(19) United States
(12) Patent Application Publication
(10) Pub. No.: US 2018/0022658 A1
(43) Pub. Date: Jan. 25, 2018

(54) ARBUSCULAR MYCORRHIZAL SEED AND IN-FURROW COMPOSITIONS CONTAINING SOYBEAN OIL AND METHODS OF THEIR USE

(71) Applicant: Valent BioSciences LLC, Libertyville, IL (US)

(72) Inventors: Bala N. Devisetty, Buffalo Grove, IL (US); Alok Adholeya, St Louis, MO (US)

(21) Appl. No.: 15/656,288

(22) Filed: Jul. 21, 2017

Related U.S. Application Data
(60) Provisional application No. 62/365,675, filed on Jul. 22, 2016.
(60) Provisional application No. 62/365,690, filed on Jul. 22, 2016.
(60) Provisional application No. 62/365,708, filed on Jul. 22, 2016.

(51) Int. Cl. C05F 11/08; C05G 3/00

(52) U.S. Cl. CPC C05F 11/08; C05G 3/0064

(57) ABSTRACT

The present invention is directed to Mycorrhizae seed and in-furrow compositions containing soybean oil. The present invention is further directed to methods of improving plant growth by applying Mycorrhizal seed treatment and in-furrow compositions containing soybean oil to a plant, plant propagation material, or an area where a plant will grow.

### FIELD OF THE INVENTION

The present invention relates to Mycorrhizal seed and in-furrow compositions containing soybean oil. The present invention further relates to methods of improving plant growth by applying Mycorrhizal seed treatment and in-furrow compositions containing soybean oil to a plant, plant propagation material, or an area where a plant will grow.

### BACKGROUND OF THE INVENTION

Huge amounts of water and fertilizer are utilized across agricultural and landscaping practices. These practices, although readily accepted and necessary, lead to an exacerbation of water quantity and quality issues across the world. For example, agriculture uses about 70% of the accessible freshwater. The water that is not used may be contaminated by dangerous chemicals found in fertilizers. Specifically, contamination of municipal water supplies by nitrates is dangerous to human health and increased phosphate content in rivers and streams leads to lower oxygen levels and possibly large-scale fish death.

Mycorrhizae are symbiotic associations between fungi (i.e. mycorrhizal fungi) and the roots of plants. Mycorrhizal fungi are associated with greater than 90% of all land plants including crops, grasses and trees. Mycorrhizal fungi provide many important benefits to plants including enhanced absorption of water and nutrients from the soil, increased drought resistance, increased pathogen resistance and protection, enhanced plant health and vigor, minimized effects of external stress, and enhanced seedling growth. In turn, the external application of Mycorrhizal fungi to plants can lead to less irrigation and fertilization, which saves water and reduces the amount of chemicals, such as nitrates and phosphorus, and almost all the micronutrients. Mycorrhizal fungi are most effective when introduced to the soil prior to seed germination or at early stages of plant root proliferation.

Current Mycorrhizae formulations include those developed by Mycorrhizal Applications, which produces liquid suspensions and wettable powders as seed treatments and in-furrow formulations. However, these formulations only contain about 7,600 propagules (“ppg's”) per gram for seed treatments, about 950 ppg's per gram for in-furrow formulations and about 280 ppg's per gram for wettable powders and have been known to clog spray nozzle screens as large as 50 mesh. Further, current Mycorrhizae formulations are not “application friendly” and lack physical stability and homogeneity.

Accordingly, there is a need to develop new Mycorrhizae formulations capable of delivering a higher concentration of Mycorrhizal fungi while maintaining prolonged and efficient viability and non-dormant propagules as well as improved physical stability and homogeneity.

### SUMMARY OF THE INVENTION

The present invention is directed to plant growth compositions containing Mycorrhizae and soybean oil.

The present invention is further directed to methods of improving plant growth by applying the compositions of the present invention to plants, plant propagation material including seeds and seedlings, or an area where a plant will grow including plant root zones and furrows.

### DETAILED DESCRIPTION OF THE INVENTION

As used herein, the terms “Mycorrhiza” or “Mycorrhizae” refers to an organic material containing a Mycorrhizal fungus and the plant roots to which the Mycorrhizal fungus is symbiotically associated. The symbiotic association of the Mycorrhizal fungus to the plant material may be either intracellular (i.e. arbuscular Mycorrhiza) or extracellular (i.e. ectomycorrhiza). Other types of Mycorrhizae, such as ericoid, arbutoid, monotropoid and Orchid Mycorrhizae, are also encompassed within the term “Mycorrhiza” or “Mycorrhizae.”

As used herein, the term “propagules” (“ppg”) refers to any mycorrhizal material capable of forming symbiosis with plant roots, such as seeds or seedlings, growing agriculture or tree crops, clonal and micro propagated plants, and the like.

As used herein, the term “plant propagation material” refers to seeds and seedlings of all kinds (fruit, tubers, and grains), clonal and micro propagated plants, and the like.

As used herein, the term “furrow” or “in-furrow” refers to a trench in the soil into which plant propagation material is placed.

As used herein, the term “plant root zones” includes the soil among and around which the plant roots reside including the rhizosphere.

As used herein, “improving” means that the plant has more of the specific quality than the plant would have had it if it had not been treated by methods of the present invention.

As used herein, all numerical values relating to amounts, weight percentages and the like are defined as “about” or “approximately” each particular value, plus or minus 10%. For example, the phrase “at least 5.0% by weight” is to be understood as “at least 4.5% to 5.5% by weight.” Therefore, amounts within 10% of the claimed values are encompassed by the scope of the claims.

As used herein % w/w denotes weight by total weight of the composition. All concentrations listed herein are in % w/w unless otherwise described.

The articles “a,” “an” and “the” are intended to include the plural as well as the singular, unless the context clearly indicates otherwise.

The terms “composition” and “formulation” are used interchangeably throughout the application.

In one embodiment, the present invention is directed to a plant growth composition comprising from about 0.2% to about 20% w/w Mycorrhizae technical powder concentrate containing 300,000 to 400,000 propagules per gram (“ppg/g”), preferably from about 0.2% to about 8% w/w Mycorrhizae technical powder concentrate or from about 1% to about 20% w/w Mycorrhizae technical powder concentrate, more preferably from about 2% to about 11% w/w or 1% to 2% w/w and most preferably about 1.5% w/w or 8.7% w/w.

In a preferred embodiment, the compositions of the present invention contain at least one excipient selected from the group consisting of an emulsifier, a rheological additive, a polar additive and a dispersing agent.

In a preferred embodiment, the compositions of the present invention contain from about 50% to about 99% w/w of a combination of an emulsifier, a rheological additive and a dispersing agent.

In a preferred embodiment, the compositions of the present invention are free of water.

In another preferred embodiment, the emulsifier is at a concentration from about 0.5% to about 11.5% w/w.

Emulsifiers suitable for use in the compositions of the present invention include, but are not limited to non-ionic, anionic, cationic, amphoteric, and other polymeric surfactants or their mixtures. Preferably, the emulsifier is non-ionic because it is easily soluble in the preferred diluent, helps in stabilizing suspension, easily forms stable emulsions, and is not phytotoxic to crops. More preferably the emulsifier is from about 0.5% to about 4% w/w Tween® 20 (polysorbate 20; Tween is a registered trademark of Croda Inc.), from about 2.5% to about 7.5% w/w Atplus® 300FA (CAS no. 73468-21-0; Atplus is a registered trademark of Croda Inc.) or a combination thereof. Atplus® 300FA is a surfactant comprised of polyol fatty acid esters and polyethoxylated derivatives thereof.

In another preferred embodiment, the rheological additive is at a concentration of from about 1.2% to about 3.0% w/w, more preferably 2% w/w.

Rheological additives suitable for use in the compositions of the present invention include, but are not limited to, organic derivatives of clays such as Bentone® 38 (Bentone is a registered trademark of Elementis Specialties, Inc.), Bentone® 34, Bentone® 27V, Bentone® 1000 and Garamite® 1958 (Garamite is a registered trademark of BYK Additives, Inc). Bentone® 27V and 38 are each an organically modified derivative of a hectorite clay. Bentone® 27V is also known as benzenemethanaminium, N,N-dimethyl-N-octadecyl-, chloride, reaction products with hectorite and has the CAS no. 94891-33-5. Bentone® 38 is also known as quaternium 18 hectorite and has the CAS no. 120001-31-9. Bentone® 34 and 1000 are each an organic derivative of a bentonite clay. Bentone® 34 is also known as quaternium 18 bentonite and has the CAS no. 68953-58-2. Bentone® 1000 has the CAS no. 887329-06-8. Garamite® 1958 is also known as alkyl quaternary ammonium clay. In a preferred embodiment, the rheological additive is Bentone® 27V or Bentone® 34.

In another preferred embodiment, the polar additive is at a concentration from about 0.5% to about 5.0% w/w, more preferably 2% w/w.

Polar additives suitable for use in the compositions of the present invention include, but are not limited to, Jeffsol® AG 1555 (Jeffsol is a registered trademark of Huntsman Corporation.) Jeffsol® AG 1555 is a propylene carbonate also known as 1,2-propanediol cyclic carbonate and has the CAS no. 108-32-7.

In another preferred embodiment, the dispersing agent is at a concentration from about 0.25% to about 25% w/w.

Dispersing agents suitable for use in the compositions of the present invention include, but are not limited to, calcium ligninsulfonate, methylcellulose, hydroxymethylcellulose, ethylene oxide-propylene oxide block polymers, alkyl-phenol polyglycol ether and tπstyrylphenol polyglycol ether and their phosphated or sulfated derivatives, polyacrylic acid salts and aryl sulfonate formaldehyde condensates, sodium bistridecyl sulfosuccinate, oxazoline compounds, sodium alkyl benzene sulfonates, octyldodecyl myristate, fumed silica, sorbitan isostearate, octyl stearate, Dapro® FX 2060 (Dapro is available from Elementis specialties), diglycerol monoisostearate, free acid of complex organic phosphate ester (Dextrol® OC-15, OC-20, Dextrol is available from Ashland), organic phosphate ester, ricinoleic acid, glycerol monoleate, POE-(4) lauryl alcohol, polyethylene glycol 400 monostearate and sorbitan monostearate.

In another embodiment, the compositions of the present invention may contain further or additional excipients such as wetting agents, preservatives, solubilizers, stabilizers, binders, film-formers, anti-foaming agents, spreaders, stickers, pH regulators, humectants, dyes, ultra-violet light protectants, a vehicle or other components which facilitate production, storage stability, product handling application and biological efficacy.

In a preferred embodiment, the compositions of the present invention comprise more than about 3,000 ppg/g or more than 20,000 ppg/g.

In another preferred embodiment, the compositions of the present invention are capable of passing through standard sieves with openings from about 105 to about 150 micrometers in diameter.

In a more preferred embodiment, the present invention is directed to a plant growth composition comprising:
from about 0.2% to about 20% w/w Mycorrhizae technical powder concentrate;
from about 0.5% to about 95% w/w soybean oil; and
optionally, at least one excipient selected from the group consisting of an emulsifier, a rheological additive, a polar additive and a dispersing agent.

In a more preferred embodiment, the present invention is directed to a seed treatment composition comprising:
from about 2% to about 11% w/w Mycorrhizae technical powder concentrate;
from about 69% to about 93% w/w soybean oil;
from about 2.5% to about 7.5% w/w of a surfactant comprising polyol fatty acid esters and polyethoxylated derivatives thereof;
from about 1.2% to about 3% w/w benzenemethanaminium, N,N-dimethyl-N-octadecyl-, chloride, reaction products with hectorite;
from about 0.5% to about 5% w/w 1,2-propanediol cyclic carbonate; and
from about 0% to about 4% w/w polysorbate 20.

In a yet more preferred embodiment, the present invention comprises polysorbate 20 at a concentration from about 0.5% to about 4% w/w.

In a most preferred embodiment, the present invention is directed to a seed treatment composition comprising:
about 8.7% w/w Mycorrhizae technical powder concentrate;
about 82% w/w soybean oil;
about 5% w/w of a surfactant comprising polyol fatty acid esters and polyethoxylated derivatives thereof;
about 2% w/w benzenemethanaminium, N,N-dimethyl-N-octadecyl-, chloride, reaction products with hectorite;
about 2% w/w 1,2-propanediol cyclic carbonate; and
about 0.5% w/w polysorbate 20.

In another preferred embodiment, the present invention is directed to a seed treatment composition comprising:
from about 1% to about 20% w/w Mycorrhizae technical powder concentrate;
from about 0.5% to about 20% w/w soybean oil; and
from about 50% to about 98% w/w of a combination of an emulsifier, a rheological additive and a dispersing agent.

In another preferred embodiment, the present invention is directed to a seed treatment composition comprising:
from about 2% to about 11% w/w Mycorrhizae technical powder concentrate;
from about 0.5% to about 20% w/w soybean oil; and
from about 59% to about 98% w/w of a combination of an emulsifier, a rheological additive and a dispersing agent.

In another preferred embodiment, the present invention is directed to a seed treatment composition comprising:
from about 0.2% to about 8% w/w Mycorrhizae technical powder concentrate;
from about 0.5% to about 20% w/w soybean oil; and
from about 62% to about 99% w/w of a combination of an emulsifier, a rheological additive and a dispersing agent.

In another preferred embodiment, the present invention is directed to a seed treatment composition comprising:
about 8.7% w/w Mycorrhizae technical powder concentrate;
about 20% w/w soybean oil; and
about 71% w/w of a combination of an emulsifier, a rheological additive and a dispersing agent.

In another preferred embodiment, the present invention is directed to an in-furrow composition comprising:
from about 1% to about 2% w/w Mycorrhizae technical powder concentrate;
from about 0.5% to about 20% w/w soybean oil; and
from about 68% to about 98% w/w of a combination of an emulsifier, a rheological additive and a dispersing agent.

In another preferred embodiment, the present invention is directed to an in-furrow composition comprising:
about 1.5% w/w Mycorrhizae technical powder concentrate;
about 20% w/w soybean oil; and
about 79% w/w of a combination of an emulsifier, a rheological additive and a dispersing agent.

Compositions of the present invention may be applied to any plant, plant propagation material thereof that may benefit from improved growth including agricultural crops, annual grasses, trees, shrubs, ornamental flowers and the like. Compositions of the present invention may further be applied to any area where a plant will grow including soil, a plant root zone and a furrow.

In another embodiment, the present invention is directed to methods of improving plant growth comprising applying a composition of the present invention to a plant, plant propagation material, preferably plant propagation material, more preferably seeds, or to an area where a plant will grow, preferably soil and more preferably a furrow or a plant root zone.

The compositions of the present invention may be applied at a rate of from about 5 to about 400 grams of Mycorrhizae formulation per hectare, preferably from about 10 to about 300 grams per hectare and more preferably from about 25 to about 300 grams per hectare.

The compositions of the present invention may be combined with or applied concomitantly or sequentially with other seed treatment formulations containing both synthetic and biological or biorational pesticides, plant growth regulators, biostimulants and/or fertilizers.

These representative embodiments are in no way limiting and are described solely to illustrate some aspects of the invention.

Further, the following example is offered by way of illustration only and not by way of limitation.

### EXAMPLES

### Example 1. Formulation of a Mycorrhizae Seed Treatment

TABLE 1

| | % w/w |
|---|---|
| Mycorrhizae technical | 8.7 |
| powder concentrate | |
| Soybean Oil | 81.8 |
| Bentone ® 27V | 2 |
| Atplus ® 300 FA | 5 |
| Jeffsol ® AG1555 | 2 |
| Tween ® 20 | 0.5 |

Initially root fragments containing Mycorrhizae propagules are reduced to a desirable size range by appropriate size reduction methods ensuring spore and propagule integrity. The processed Mycorrhizae technical powder concentrate is capable of passing through a standard sieve #100 (i.e. 149 micrometers) to a standard #140 mesh (i.e. 105 micrometers) sieve. A free-flow agent such as Silicondioxide available under various trade names such as Zeofree® 80 (Zeofree® is a registered trademark of J.M. Huber Corporation) may be used to aid in propagule size reduction. Zeofree® 80 has the CAS No. 112926-008. Bentone 27V is first dispersed in soybean oil under high shear mixing followed by the addition and mixing of Atplus 300FA and propylene carbonate. Mycorrhizae technical powder concentrate is then added and dispersed until a homogenous suspension is obtained. In the final step, Tween 20 is added and mixed.

The resultant suspension is stable and easy to handle and forms a stable emulsion upon addition to aqueous mixtures in the tank. The spores maintain their viability in the suspension.

### Example 2. Formulation of a Mycorrhizae Seed Treatment

TABLE 2

| | % w/w |
|---|---|
| Mycorrhizae technical | 8.73 |
| powder concentrate | |
| Geronol ® Odessa 01 | 71.27 |
| Soybean oil | 20 |

Initially, root fragments containing Mycorrhizae propagules are reduced to desirable size range by appropriate size reduction methods ensuring spore and propagule integrity. The processed Mycorrhizae technical powder concentrate is capable of passing through a standard sieve #100 (i.e. 149 micrometers) to a standard #140 (105 micrometers) sieve. A free-flow agent such as silicon dioxide available under brand names such as Zeofree® 80 (Zeofree® 80 is a registered trade mark of J.M. Huber Corporation] may be used as an aid in propagule size reduction and further handling. Zeofree® 80 has the CAS #: 112926-00-8.

The required amount of soybean oil is added to Geronol® Odessa 01 and mixed until homogenous. Geronol® Odessa 01 (Geronol is a registered trademark of Solvay) is a proprietary vegetable oil based oil dispersion that also includes an emulsifier, a rheological additive and a dispersing agent. The Mycorrhizae technical powder super concentrate is then added and dispersed under high shear and mixed until a homogenous suspension is obtained. The resulting formulation will be storage stable and contain good flow and mixing properties. The formulations will also maintain fungal spore viability.

### Example 3. Formulation of a Mycorrhizae In-Furrow Composition

TABLE 3

| | % w/w |
|---|---|
| Mycorrhizae | 1.5 |
| Geronol ® Odessa 01 | 78.5 |
| Soybean oil | 20 |

Initially, root fragments containing Mycorrhizae propagules are reduced to a desirable size range by appropriate size reduction methods ensuring spore and propagule integrity. The processed Mycorrhizae powder concentrate is capable of passing through a standard sieve #100 (i.e. 149 micrometers) to a standard #140 (105 micrometers) sieve. A free-flow agent such as silicon dioxide available under brand names such as Zeofree® 80 (Zeofree® 80 is a registered trade mark of J.M. Huber Corporation] may be used as an aid in propagule size reduction and further handling. Zeofree® 80 has the CAS #: 112926-00-8.

The resulting formulation will be storage stable and contain good flow properties. The formulations will also maintain fungal spore viability.

### Example 4. Physical Properties of Mycorrhizae Compositions Containing Soybean Oil

TABLE 4

| | Example 1 | Example 2 | | | | Myco Apply |
|---|---|---|---|---|---|---|
| | Seed | Seed | Formulation #4 | Formulation #5 | Example 3 | Liquid Endo |
| | Treatment | Treatment | Seed Treatment | In-furrow | In-furrow | Seed & Furrow |
| Carrier | Soybean | Soybean | Soybean Oil | Soybean Oil | Soybean | Water |
| | Oil | Oil/Odessa | | | Oil/Odessa | |
| Mycorrhizae | 8.73 | 8.73 | 7.40 | 1.46 | 1.46 | 2.5 |
| Concentration | | | | | | |
| (% w/w) | | | | | | |
| Mycorrhizae | 22,836 | 22,836 | 22,836 | 3,808 | 3,808 | 7,612 |
| Concentration | | | | | | |
| (ppg/g) | | | | | | |
| Viscosity | 417 | 832 | 414 | 286 | 1,190 | Not |
| (T = 0) | (27.1° C.) | (26.1° C.) | (22.4° C.) | (27.3° C.) | (25.5° C.) | detected |
| (centipoise) | | | | | | |
| Density | 0.934 | 0.926 | 0.960 | 0.936 | 0.938 | 1.015 |
| (g/mL) | | | | | | |

As shown in Table 4, the compositions of the present invention have a greater viscosity profile and lower density than prior art Mycorrhizae compositions. Further, the compositions of the present invention contain three times the standard 7,612 ppg/g concentration of Mycorrhizae used for seed treatments and four times the standard 952 ppg/g concentration of Mycorrhizae used for in-furrow applications.

### Example 5. Stability of Mycorrhizae Compositions Containing Soybean Oil

Prior art formulations and compositions of the present invention were formulated and packaged for suspendibility testing.

TABLE 5

| | MycoApply Liquid | Example 1 Seed | Example 2 | Example 3 |
|---|---|---|---|---|
| | Endo Seed & Furrow | Treatment | Seed Treatment | In-furrow |
| | Bottom Settling of | Settling of | Settling of | Settling of |
| | propagules | propagules | propagules | propagules |
| Time | to the bottom | to the | to the | to the |
| (Min) | (%) | bottom (%) | bottom (%) | bottom (%) |
| 1 | 8.4 | 0.0 | 0.0 | 0.0 |
| 2 | 11.6 | 0.0 | 0.0 | 0.0 |
| 3 | 14.0 | 0.0 | 0.0 | 0.0 |
| 4 | 16.0 | 0.0 | 0.0 | 0.0 |
| 5 | 17.6 | 0.0 | 0.0 | 0.0 |
| 6 | 19.6 | 0.0 | 0.0 | 0.0 |
| 7 | 20.8 | 0.0 | 0.0 | 0.0 |
| 8 | 22.8 | 0.0 | 0.0 | 0.0 |
| 9 | 25.4 | 0.0 | 0.0 | 0.0 |
| 10 | 26.0 | 0.0 | 0.0 | 0.0 |

As shown in Table 5, MycoApply Liquid Endo Seed & Furrow composition contains approximately 26% solids. All solids in this prior art aqueous formulation settled out to the bottom of the container within 10 minutes. In contrast, propagules in the soybean oil compositions of the present invention remain stable for over 12 months demonstrating excellent stability.

### Example 6. Bio-Efficacy of Mycorrhizae Compositions Containing Soybean Oil

Prior art formulations and compositions of the present invention were diluted to standard tank-mix Mycorrhizae application concentrations in water for either seed treatment or in-furrow application and applied to corn seeds or in-furrow in the green house. Mycorrhizae colonization was determined at harvest and is presented in Table 6 as a percent root length colonization by Arbuscular mycorrhizae in corn.

TABLE 6

| | Unformulated | | | | |
|---|---|---|---|---|---|
| | Mycorrhizae | MycoApply | Example 1 | Example 2 | Example 3 |
| Formulation | Concentrate | EndoMaxx | Seed Treatment | Seed Treatment | In-furrow |
| Concentration | 313,845 | 22,500 | 22,836 | 3,808 | 3,808 |
| (ppg/g) | | | | | |
| % Arbuscular | 8.95% | 10.94% | 10.53% | 12.07% | 13.49% |
| mycorrhizal | | | | | |
| Colonization | | | | | |

As shown in Table 6, seeds treated with the formulation of Examples 1 and 2 resulted in 10.94% and 10.53% of corn at harvest being colonized with Mycorrhizae, and 13.94% of corn grown in-furrows treated with the composition of Example 3 were colonized with Mycorrhizae. These results are comparable to that of commercial MycoApply EndoMaxx (10.94%) and were higher than unformulated Mycorrhizae concentrate (8.95%). Further, compositions of the present invention showed similar or better uptake of nutrients including nitrogen, phosphorous, potassium, zinc, iron, boron and molybdenum in plant shoots as compared to MycoApply EndoMaxx.

### Example 7. Spore Viability of Mycorrhizae Compositions Containing Soybean Oil

Unformulated Mycorrhizae concentrate and compositions of the present invention were stored at variable ambient temperature, and at constant 5° C., 25° C. and 30° C. for 12 months. Mycorrhizae spore viability was measured as a percent of total spores and is presented below in Tables 7 and 8.

TABLE 7

| Formulation | 0 Months | 12 Months |
|---|---|---|
| Unformulated Mycorrhizae | 46% | 38% |
| Concentrate | | |
| Example 1 Seed Treatment | 88% | 60% |
| Example 2 Seed Treatment | 76% | 59% |
| Example 3 In-Furrow | 63% | 74% |

TABLE 8

| | 3 months | | | 12 months | | |
|---|---|---|---|---|---|---|
| Formulation | 5° C. | 25° C. | 30° C. | 5° C. | 25° C. | 30° C. |
| Example 2 | 71% | 50% | 63% | 78% | 74% | 79% |
| Seed Treatment | | | | | | |
| Formulation #4 | 60% | 59% | 83% | X | X | 84% |
| Example 3 In-furrow | 55% | X | X | 77% | 90% | 61% |

X denotes data point not recorded

As seen in Tables 7 and 8 soybean oil compositions of the present invention maintained spore viability over 1 year under variable ambient storage conditions and at constant storage temperatures of 5° C., 25° C., and 30° C.

What is claimed is:

1. A plant growth composition comprising from about 0.2% to about 20% w/w Mycorrhizae technical powder concentrate and from about 0.5% to about 95% w/w soybean oil, wherein % w/w denotes percent weight by total weight of the composition.

2. The composition of claim 1, wherein the composition is free of water.

3. The composition of claim 1, further comprising at least one excipient selected from the group consisting of an emulsifier, a rheological additive, a polar additive and a dispersing agent.

4. The composition of claim 1, further comprising from about 50% to about 99% w/w of a combination of an emulsifier, a rheological additive and a dispersing agent.

5. The composition of claim 1, further comprising from about 0.5% to about 11.5% w/w of an emulsifier.

6. The composition of claim 5, wherein the emulsifier is selected from the group consisting of from about 0.5% to about 4% w/w polysorbate 20, from about 2.5% to about 7.5% w/w of a surfactant comprising polyol fatty acid esters and polyethoxylated derivatives thereof, and a combination thereof.

7. The composition of claim 1, further comprising from about 1.2% to about 3.0% w/w of a rheological additive.

8. The composition of claim 7, wherein the rheological additive is an organic derivative of a bentonite clay.

9. The composition of claim 1, further comprising from about 0.5% to about 5% w/w of a polar additive.

10. The composition of claim 1, wherein the composition comprises more than about 3,000 propagules per gram.

11. The composition of claim 1, wherein the composition comprises more than about 20,000 propagules per gram.

12. A seed treatment composition comprising:
from about 2% to about 11% w/w Mycorrhizae technical powder concentrate;
from about 69% to about 93% w/w soybean oil;
from about 2.5% to about 7.5% w/w of a surfactant comprising polyol fatty acid esters and polyethoxylated derivatives thereof;
from about 1.2% to about 43.0% w/w benzenemethanaminium, N,N-dimethyl-N-octadecyl-, chloride, reaction products with hectorite;
from about 0.5% to about 5% w/w 1,2-propanediol cyclic carbonate; and
from about 0% to about 4% w/w polysorbate 20,
wherein % w/w denotes percent weight by total weight of the composition.

13. The seed treatment composition of claim 12 comprising:
about 8.7% w/w Mycorrhizae technical powder concentrate;
about 82% w/w soybean oil;
about 5% w/w of a surfactant comprising polyol fatty acid esters and polyethoxylated derivatives thereof;
about 2% w/w benzenemethanaminium, N,N-dimethyl-N-octadecyl-, chloride, reaction products with hectorite;
about 2% w/w 1,2-propanediol cyclic carbonate; and
about 0.5% w/w polysorbate 20.

14. A seed treatment composition comprising:
from about 2% to about 11% w/w Mycorrhizae technical powder concentrate;
from about 0.5% to about 20% w/w soybean oil; and
from about 59% to about 98% w/w of a combination of an emulsifier, a rheological additive and a dispersing agent,
wherein % w/w denotes percent weight by total weight of the composition.

15. The seed treatment composition of claim 14 comprising:
about 8.7% w/w Mycorrhizae technical powder concentrate;
about 20% w/w soybean oil; and
about 71% w/w of a combination of an emulsifier, a rheological additive and a dispersing agent.

16. An in-furrow composition comprising:
from about 1% to about 2% w/w Mycorrhizae technical powder concentrate
from about 0.5% to about 20% w/w soybean oil; and
from about 68% to about 99% w/w of a combination of an emulsifier, a rheological additive and a dispersing agent,
wherein % w/w denotes percent weight by total weight of the composition.

17. The in-furrow composition of claim 16, comprising:
about 1.5% w/w Mycorrhizae technical powder concentrate;
about 20% w/w soybean oil; and
about 79% w/w of a combination of an emulsifier, a rheological additive and a dispersing agent.

18. A method of improving plant growth comprising applying a composition of claim 1 to a plant, plant propagation material or an area where a plant will grow.

19. The method of claim 18, wherein the composition is applied to seeds.

20. The method of claim 18, wherein the composition is applied to an area where a plant will grow and wherein the area will a plant will grow is soil in the form of a furrow.
